(19) United States
(12) Patent Application Publication
(10) Pub. No.: US 2024/0305728 A1
(43) Pub. Date: Sep. 12, 2024

(54) OPERATION DETECTING DEVICE AND IMAGE FORMING APPARATUS

(71) Applicant: KYOCERA Document Solutions Inc., Osaka (JP)

(72) Inventor: Hitoshi Matsumoto, Osaka (JP)

(21) Appl. No.: 18/590,812

(22) Filed: Feb. 28, 2024

(30) Foreign Application Priority Data
Mar. 6, 2023 (JP) 2023-033399

(51) Int. Cl. H04N 1/00

(52) U.S. Cl. CPC H04N 1/00689; H04N 1/00694; H04N 1/00904

(57) ABSTRACT

An operation sound output portion outputs a sound corresponding to an operation when a ringing signal is input. A control portion is capable of outputting a ringing command signal in a normal state. The control portion transitions to a paused state with lower power consumption than the normal state when a pause condition is satisfied in the normal state. An OR circuit outputs a logical OR signal of an operation detection signal of an operation detecting portion and a ringing command signal to the operation sound output portion as the ringing signal.

### INCORPORATION BY REFERENCE

This application is based upon and claims the benefit of priority from the corresponding Japanese Patent Application No. 2023-033399 filed on Mar. 6, 2023, the entire contents of which are incorporated herein by reference.

### BACKGROUND

The present disclosure relates to an operation detecting device that outputs sound corresponding to an operation and an image forming apparatus.

An image forming apparatus such as a printer, a copier, or a multifunction peripheral includes a printing device, an operation detecting device, a display device, and a control device. The printing device executes a printing process to form an image on a sheet.

For example, the operation detecting device includes one or both of operation keys and a touch panel. The display device includes a panel display device such as a liquid crystal display panel.

The control device executes various types of data processing and control of various types of electrical devices in the image forming apparatus.

The image forming apparatus operates in a normal mode or a power saving mode. The power saving mode is an operation mode that consumes less power than the normal mode.

The control device causes the image forming apparatus to transition to the power saving mode when a pause condition is satisfied in the normal mode. The control device transitions from a normal state to a paused state when causing the image forming apparatus to transition from the normal mode to the power saving mode.

In addition, it is known that the image forming apparatus has a notification function of giving a notification of the return from the power saving mode to the normal mode by generating a sound.

### SUMMARY

An operation detecting device according to an aspect of the present disclosure includes an operation detecting portion, an operation sound output portion, a control portion, and an OR circuit. The operation detecting portion detects a human operation. The operation sound output portion outputs a sound corresponding to the operation when a ringing signal is input. The control portion is capable of outputting a ringing command signal in a normal state, and when a pause condition is satisfied in the normal state, transitions to a paused state with lower power consumption than the normal state. The OR circuit outputs a logical OR signal of an operation detection signal of the operation detecting portion and a ringing command signal to the operation sound output portion as the ringing signal.

An image forming apparatus according to another aspect of the present disclosure includes a printing device that forms an image on a sheet, and the operation detecting device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming apparatus including an operation detecting device according to a first embodiment.

FIG. 2 is a block diagram showing a configuration of an operation detecting device according to the first embodiment.

FIG. 3 is a block diagram showing a configuration of an operation detecting device according to the first embodiment.

FIG. 4 is a block diagram showing a configuration of an operation detecting device according to the first embodiment.

### DETAILED DESCRIPTION

Embodiments according to the present disclosure will be described below with reference to the drawings. Note that the following embodiments are examples of embodying a technique according to the present disclosure, and do not limit the technical scope of the present disclosure.

### First Embodiment

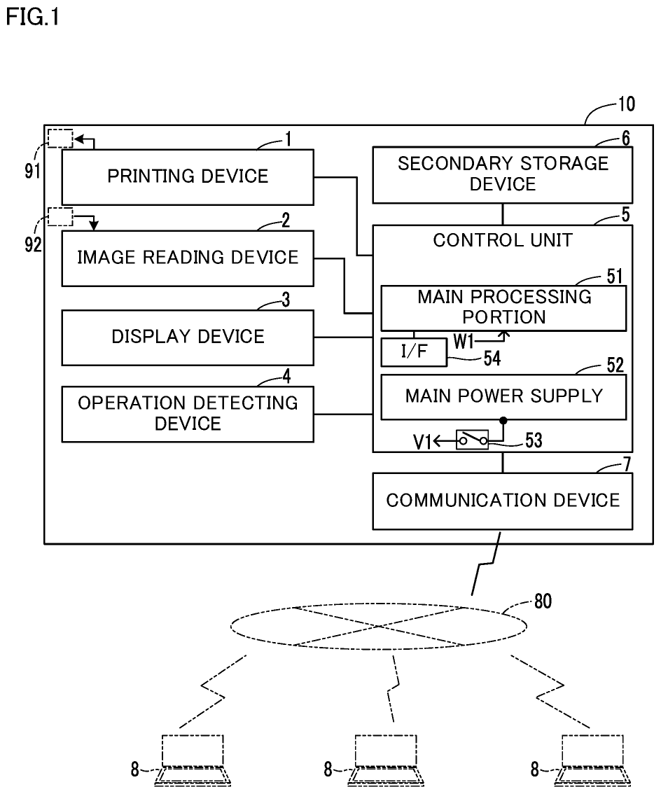

An operation detecting device 4 according to a first embodiment constitutes a part of an image forming apparatus 10 (see FIG. 1).

The image forming apparatus 10 includes a printing device 1, an image reading device 2, a display device 3, an operation detecting device 4, a control unit 5, a secondary storage device 6, a communication device 7, and the like (see FIG. 1).

The printing device 1 executes a printing process to form an image on paper 91. The paper 91 is a sheet-shaped image forming medium. The paper 91 is an example of a sheet.

For example, the printing device 1 executes the printing process using an electrophotographic method or an inkjet method. The printing device 1 includes a paper conveying device that conveys the paper 91. The printing device 1 forms an image on the paper 91 that is conveyed by the paper conveying device.

The image reading device 2 executes a reading process of reading an image from a document 92. The image reading device 2 includes a document conveying device that conveys a document 92. The image reading device 2 reads an image from the document 92 conveyed by the document conveying device.

The display device 3 can display various types of information. For example, the display device 3 is a panel display device such as a liquid crystal display panel.

The operation detecting device 4 is capable of detecting a human operation. The operation detecting device 4 detects operations related to the printing process and the image reading process. For example, the operation detecting device 4 detects an operation for instructing the image forming apparatus 10 to start the printing process or the image reading process.

The control unit 5 controls various types of devices included in the image forming apparatus 10. The control unit 5 includes a main processing portion 51, a main power supply 52, a switch circuit 53, and a device communication interface 54 (see FIG. 1).

The main power supply 52 converts an AC voltage input from the outside into a DC voltage, and supplies the DC voltage to various types of devices in the image forming apparatus 10.

The main processing portion 51 includes a processor that executes various types of data processing and control by executing computer programs. For example, the main processing portion 51 is achieved by a system on a chip (SOC).

For example, the main processing portion 51, by controlling the printing device 1, causes the printing device 1 to execute the printing process. In addition, the main processing portion 51 also, by controlling the image reading device 2, causes the image reading device 2 to execute the reading process.

The device communication interface 54 is an interface for device communication that the main processing portion 51 executes with other devices in the image forming apparatus 10. The device communication is, for example, serial communication. The main processing portion 51 communicates with the operation detecting device 4 via the device communication interface 54.

For example, the main processing portion 51 acquires detection results of the operation detecting device 4 via the device communication interface 54.

The secondary storage device 6 is a nonvolatile storage device such as a flash memory or a hard disk drive. The secondary storage device 6 stores the computer programs executed by the main processing portion 51 and various types of data.

The communication device 7 is a communication interface that executes communication with other devices such as a host device 8 via a network 80. The network 80 includes a wireless local area network (LAN), a wired LAN, or the like. The host device 8 is a computer, a mobile terminal, or the like operated by a user of the image forming apparatus 10. The host device 8 is an example of a device outside the image forming apparatus 10.

When the main processing portion 51 receives a print request from the host device 8 via the communication device 7, the main processing portion 51 causes the printing device 1 to execute the printing process. In this case, the main processing portion 51 receives image data to be printed from the host device 8.

In addition, the main processing portion 51 is also able to store the image data received from the host device 8 in the secondary storage device 6. Moreover, the main processing portion 51 is also able to store image data representing an image read from the document 92 by the image reading device 2 in the secondary storage device 6.

Furthermore, the main processing portion 51 is also able to cause the printing device 1 to execute the printing process based on the image data stored in the secondary storage device 6.

The image forming apparatus 10 is capable of operating in a normal mode or a power saving mode. In the normal mode, the main power supply 52 supplies power to the printing device 1, the image reading device 2, the display device 3, the operation detecting device 4, and the main processing portion 51.

The power saving mode is an operation mode that consumes less power than the normal mode. The main processing portion 51 causes the image forming apparatus 10 to transition to the power saving mode when a pause condition is satisfied in the normal mode.

More specifically, when the pause condition is satisfied, the main processing portion 51, by controlling the switch circuit 53, stops the supply of power from the main power supply 52 to the printing device 1, the image reading device 2, and the display device 3.

The switch circuit 53 switches from one of a state of supplying an output voltage V1 of the main power supply 52 to a target load and a state of not supplying the output voltage V1 to the other state according to a command from the main processing portion 51. The target load include the printing device 1, the image reading device 2, and the display device 3.

For example, the pause condition includes a standby condition in which a standby state continues for more than a predetermined time. The standby state is a state in which no operation is detected by the operation detecting device 4 and no request such as the print request is received by the communication device 7.

In addition, the pause condition may include a pause operation condition or a pause reception condition. The pause operation condition is a condition that the operation detection device 4 detects a predetermined pause operation. The pause reception condition is a condition that a predetermined pause command is received from the host device 8 via the communication device 7.

In the power saving mode, power supply to the printing device 1, the image reading device 2, and the display device 3 is stopped. In addition, in the power saving mode, the main processing portion 51 operates in a sleep state in which power consumption is lower than in the standard state. That is, the main processing portion 51 transitions from the standard state to the sleep state when the pause condition is satisfied.

The main processing portion 51 is supplied with power from the main power supply 52 in both the standard state and the sleep state. The main processing portion 51 transitions from the sleep state to the standard state when a return signal W1 is input while in the sleep state.

The communication device 7 outputs a return signal W1 to the main processing portion 51 when data is received from the host device 8 while in the power saving mode. In addition, the operation detecting device 4 outputs a return signal W1 to the main processing portion 51 when a predetermined return operation is detected while in the power saving mode.

When transitioning from the sleep state to the standard state, the main processing portion 51 causes the image forming apparatus 10 to transition from the power saving mode to the normal mode by controlling the switch circuit.

### Configuration of the Operation Detecting Device 4

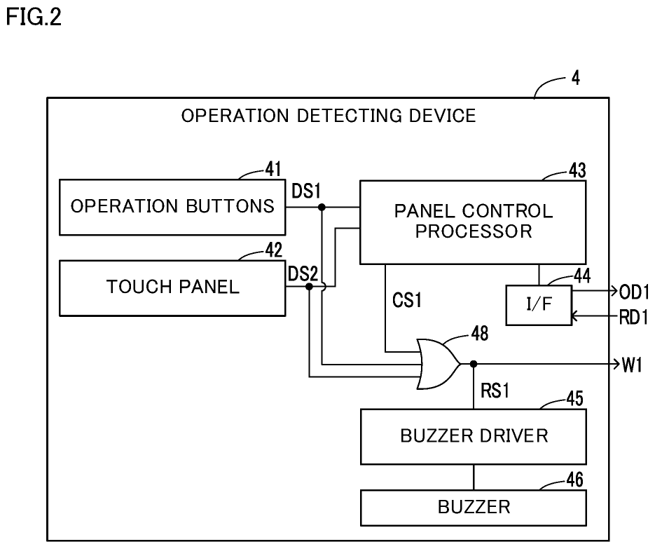

As shown in FIG. 2, the operation detecting device 4 includes operation buttons 41, a touch panel 42, a panel control processor 43, and a device communication interface 44 The operation buttons 41 and the touch panel 42 are each an example of an operation detecting portion that detects a human operation.

The panel control processor 43 is able to acquire detection results of the operation buttons 41 and the touch panel 42. That is, an operation detection signal DS1 of the operation buttons 41 and an operation detection signal DS2 of the touch panel 42 are input to the panel control processor 43.

The device communication interface 44 is an interface for the device communication executed by the panel control processor 43 with the main processing portion 51. The panel control processor 43 transmits data to the main processing portion 51 via the device communication interface 44 and receives data from the main processing portion 51.

The panel control processor 43 is supplied with power from the main power supply 52 when the image forming apparatus 10 is in the normal mode. The state in which the panel control processor 43 is supplied with the output voltage V1 of the main power supply 52 is the energized state of the panel control processor 43.

The panel control processor 43 executes an operation data transmission process when the operation detection signal DS1 or DS2 is input from the operation buttons 41 or the touch panel 42 in the energized state.

The operation data transmission process is a process of transmitting operation data OD1 representing the contents of the input operation detection signal DS1 or DS2 to the main processing portion 51 via the device communication interface 44 (see FIG. 2).

The main processing portion 51, when the operation data OD1 is received, executes a process corresponding to the operation data OD1. The main processing portion 51 is an example of a host device.

The operation detecting device 4 of the image forming apparatus 10 has a function of outputting an operation sound in the normal mode. The operation sound is a sound corresponding to an operation detected by the operation detection device 4.

In the present embodiment, the operation sounds are sounds corresponding to operations detected by the operation buttons 41 and the touch panel 42, respectively. For example, the operation sound is a “beep” sound for each operation.

In order to reduce the power consumption of the image forming apparatus 10 in the power saving mode, it is effective to stop power supply to devices required for outputting the operation sounds in the power saving mode.

On the other hand, when the image forming apparatus 10 returns from the power saving mode to the normal mode in response to the return operation, it is desirable that the operation sound is immediately output in response to the return operation.

However, in a case where a device that requires output of the operation sound is activated in response to the return operation, the output of the operation sound is delayed only by the time required for activation of the device.

The operation detecting device 4 has a configuration for immediately outputting the operation sound corresponding to the return operation while reducing the power consumption of the devices of the image forming apparatus 10 in the power saving mode as much as possible. The configuration will be explained below.

In the present embodiment, the target load whose power supply state is selected by the switch circuit 53 includes the panel control processor 43. That is, when the image forming apparatus 10 is in the power saving mode, the panel control processor 43 is not supplied with power.

When transitioning from the standard state to the sleep state, the main processing portion 51 causes the panel control processor 43 to transition from an energized state to a power supply stopped state. On the other hand, when the main processing portion 51 transitions from the sleep state to the standard state, the main processing portion 51 causes the panel control processor 43 to transition from the power supply stopped state to the energized state.

The energized state of the panel control processor 43 is an example of the normal state of the panel control processor 43. In addition, the power supply stopped state of the panel control processor 43 is an example of a paused state having less power consumption than the normal state. The panel control processor 43 is an example of a control portion in the operation detecting device 4.

As shown in FIG. 2, the operation detecting device 4 further includes a buzzer driver 45, a buzzer 46, and an OR circuit 48.

The buzzer driver 45 outputs a drive signal to the buzzer 46 when a ringing signal RS1 is input. The buzzer 46 outputs the operation sound when the drive signal is input. The buzzer driver 45 and the buzzer 46 are examples of an operation sound output portion that outputs the operation sound in response to input of the ringing signal RS1.

In the energized state, the panel control processor 43 executes a ringing command output process in addition to the operation data transmission process. The ringing command output process is a process of outputting the ringing command signal CS1 corresponding to the ringing data RD1 to the OR circuit 48 when the ringing data RD1 is received from the main processing portion 51 via the device communication interface 44.

For example, in order to cause the buzzer 46 to output an alarm sound, the main processing portion 51 transmits ringing data RD1 corresponding to the alarm sound to the panel control processor 43 via the device communication.

In the present embodiment, the operation buttons 41, the touch panel 42, the buzzer driver 45, and the OR circuit 48 are supplied with power in both the normal mode and the power saving mode. The operation detection signals DS1 and DS2 are transmitted to the panel control processor 43 and the OR circuit 48.

The OR circuit 48 outputs a logical OR signal of the operation detection signals DS1 and DS2 and the sound command signal CS1 to the buzzer driver 45 as the sound signal RS1. Thus, the buzzer driver 45 outputs the drive signal to the buzzer 46, and the buzzer 46 outputs a sound corresponding to the ringing signal RS1.

In addition, the ringing signal RS1 output from the OR circuit 48 is transmitted to the main processing portion 51 as a return signal W1. As a result, the main processing portion 51 transitions from the sleep state to the standard state in response to an operation of the operation buttons 41 or the touch panel 42.

As described above, when the image forming apparatus 10 is in the power saving mode, the panel control processor 43 of the operation detecting device 4 is in the power supply stopped state. Thus, the power consumption of the operation detecting device 4 is reduced when the image forming apparatus 10 is in the power saving mode.

In addition, even when the panel control processor 43 is in the power supply stopped state, the operation sound is immediately output when operating the operation buttons 41 or the touch panel 42. In the present embodiment, the operating the operation buttons 41 or the touch panel 42 is an example of the return operation.

By employing the operation detecting device 4, it is possible to immediately output the operation sound corresponding to the return operation while minimizing the power consumption of the devices when the image forming apparatus 10 is in the power saving mode.

### Second Embodiment

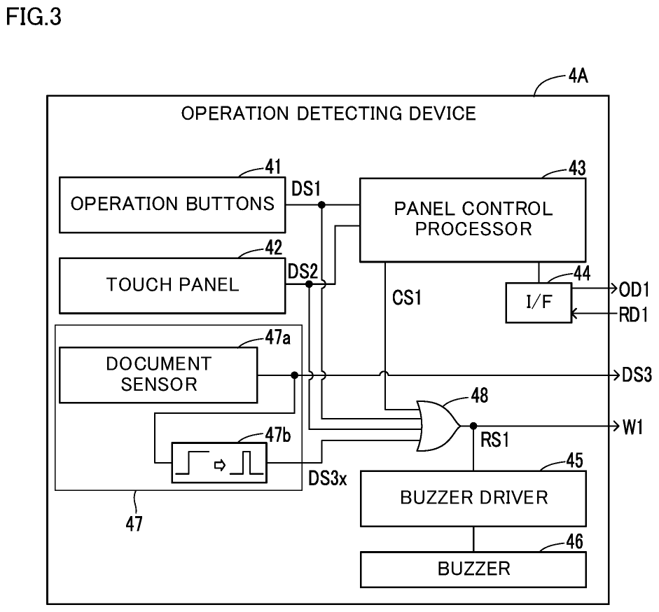

Next, an operation detecting device 4A according to a second embodiment will be described with reference to FIG. 3. Hereinafter, a configuration of the operation detecting device 4A that is different from the operation detecting device 4 will be explained.

The operation detecting device 4A has a configuration in which a sheet placement operation detecting portion 47 is added to the operation detecting device 4. The sheet placement operation detecting portion 47 detects an operation of placing a document 92 on a document tray (not shown). The document tray is provided in the image reading device 2.

The sheet placement operation detecting portion 47 includes a document sensor 47a and a one-shot circuit 47b. The document sensor 47a detects a document 92 placed on the document tray. The document 92 is an example of a sheet, the document tray is an example of a sheet tray, and the document sensor 47a is an example of a sheet detection portion.

For example, the document sensor 47a includes a displacement member and a photosensor. The displacement member is displaced by the weight of the document 92 placed on the document tray. The photosensor detects displacement of the displacement member.

The document sensor 47a outputs a first detection signal DS3 when detecting the document 92. The first detection signal DS3 is transmitted to the main processing portion 51 and the one-shot circuit 47b. The main processing portion 51 executes processing according to the input of the first detection signal DS3.

The one-shot circuit 47b outputs a pulse signal to the OR circuit 48 as a second detection signal DS3x when the first detection signal DS3 changes from a negative state to an active state.

The one-shot circuit 47b outputs a pulse signal having a width corresponding to the output time of the operation sound as the second detection signal DS3x. The OR circuit 48 outputs a logical OR signal of the operation detection signals DS1 and DS2 and the second detection signal DS3x as the ringing signal RS1 and the return signal W1.

In the present embodiment, the return operation is an operation of operating the operation buttons 41 and the touch panel 42, and an operation of placing the document 92 on the document tray.

The first detection signal DS3 and the second detection signal DS3x are each an example of an operation detection signal of the sheet placement operation detecting portion 47. In addition, the first detection signal DS3 is also an example of a sheet detection signal.

The operation detecting device 4A can immediately output the operation sound in response to the operation of placing the document 92 on the document tray even when the panel control processor 43 is in the power supply stopped state.

Even in a case where the operation detecting device 4A is employed, the same effects as when the operation detecting device 4 is employed can be obtained.

### Third Embodiment

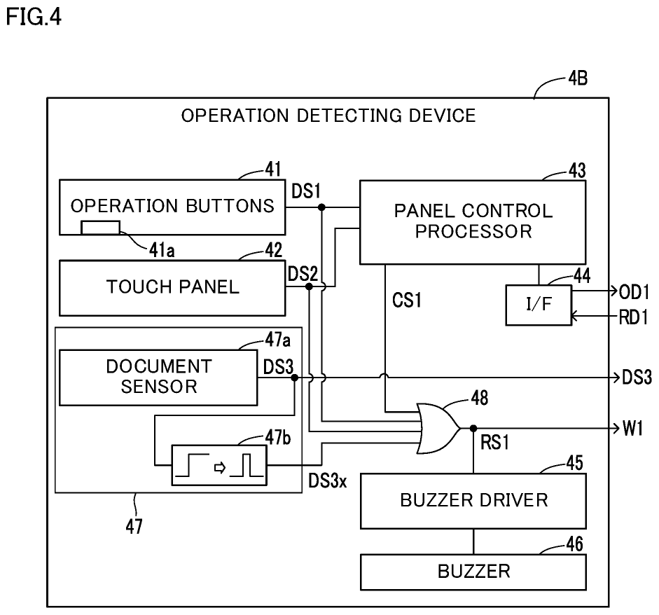

Next, an operation detecting device 4B according to a third embodiment will be described with reference to FIG. 4. The operation detecting device 4B is an application example of the operation detecting device 4A. Hereinafter, a configuration of the operation detecting device 4B that is different from the operation detecting device 4A will be explained.

The operation detecting device 4B has a configuration in which a return button 41a is added to the operation buttons 41 of the operation detecting device 4A.

In the present embodiment, the touch panel 42 is not supplied with power in the power saving mode. Furthermore, power is not supplied to any of the operation buttons 41 other than the return button 41a in the power saving mode.

In the present embodiment, the return operation is an operation of operating the return button 41a and an operation of placing a document 92 on the document tray.

The operation detecting device 4B consumes less power than the operation detecting devices 4 and 4A when the image forming apparatus 10 is in the power saving mode.

In addition, even in a case where the panel control processor 43 is in the power supply stopped state, the operation detecting device 4B can immediately output the operation sound in response to an operation of the return button 41a and an operation of placing the document 92 on the document tray.

Even in a case where the operation detecting device 4B is employed, the same effects as when the operation detecting devices 4 and 4A are employed can be obtained.

### Application Example

In the operation detecting devices 4, 4A, and 4B, the paused state of the panel control processor 43 may be a sleep state similar to that of the main processing portion 51.

### Supplemental Notes

Hereinafter, a summary of the disclosure extracted from the above-described embodiments will be added. Note that each configuration and each processing function described in the following supplementary notes can be selected and combined as desired.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An operating detecting device comprising:
an operation detecting portion configured to detect human operations;
an operation sound output portion configured to output a sound corresponding to the operation when a ringing signal is input;
a control portion capable of outputting a ringing command signal in a normal state, and configured to transition to a paused state with lower power consumption than the normal state when a pause condition is satisfied in the normal state; and
an OR circuit configured to output a logical OR signal of an operation detection signal of the operation detecting portion and the ringing command signal to the operation sound output portion as the ringing signal.

2. The operating detecting device according to claim 1, wherein
the operation detecting portion includes a sheet placement operation detecting portion configured to detect an operation of placing a sheet on a sheet tray; and
the sheet placement operation detecting portion includes:
a sheet detection portion configured to detect the sheet placed on the sheet tray; and
a one-shot circuit configured to output a pulse signal as the operation detection signal when a sheet detection signal of the sheet detection portion changes from a negative state to an active state.

3. The operating detecting device according to claim 1, wherein
the paused state is a state in which power is not supplied to the control portion, and
the control portion, in the normal state, transmits operation data representing the content of the operation detection signal to a host device via communication when the operation detection signal is input, and outputs the ringing command signal corresponding to the ringing data to the OR circuit when ringing data is received from the host device via communication.

4. An image forming apparatus, comprising:
a printing device configured to form an image on paper; and
the operating detecting device according to claim 1.
